(19) United States
(12) Patent Application Publication
(10) Pub. No.: US 2015/0085670 A1
(43) Pub. Date: Mar. 26, 2015

(54) LTE PROBE

(71) Applicant: Subsentio, Inc., Centennial, CO (US)

(72) Inventor: Glenford J. Myers, Portland, OR (US)

(21) Appl. No.: 14/475,312

(22) Filed: Sep. 2, 2014

Related U.S. Application Data
(60) Provisional application No. 61/881,814, filed on Sep. 24, 2013.
(60) Provisional application No. 61/895,792, filed on Oct. 25, 2013.

(51) Int. Cl. H04L 29/06

(52) U.S. Cl. CPC H04L 63/306; H04L 65/1096
USPC 370/241

(57) ABSTRACT

A probe is disclosed that is capable of providing the lawful interception of communications over a network, such as an LTE network. In embodiments, the probe is a passive probe operable to tap into various different interfaces on the network and intercept communications for law enforcement or intelligence agencies without modification of any hardware or software that is part of the network.

### RELATED APPLICATIONS

This application claims the benefit of U.S. Provisional Application No. 61/881,814, filed on Oct. 2, 2013, and U.S. Provisional Application No. 61/895,792, filed on Oct. 25, 2013, both of which are hereby incorporated by reference in their entirety.

### INTRODUCTION

Network providers are often required to assist law enforcement agencies with the lawful intercept of communications transmitted over their networks. However, changes in network topology or advances in network protocol often make it hard to adapt network equipment to facilitate lawful interception of communications. It is with respect to this general environment that embodiments disclosed herein are contemplated.

### Passive Probe for Lawful Intercept

Embodiments of the present disclosure relate to a standalone probe that is connected to a network, such as a Long Term Evolution (LTE) network or 4G LTE network, to lawfully intercept voice and data communications distributed over the network. In embodiments, the probe is a passive probe that can attach to multiple network segments and perform deep packet inspection to determine whether a particular voice or data communication should be lawfully intercepted. The passive probe is capable of intercepting data without requiring modification of software or equipment that is part of the network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an embodiment of a probe 100 capable of performing lawful intercept of communication transmitted over a network.

FIG. 2 is an embodiment of a passive probe 202 interfacing with an LTE network 200.

FIG. 3 is an embodiment of a passive probe 302 interfacing with an LTE network 300 having an alternate topology.

FIG. 4 is an embodiment of a passive probe 402 interfacing with an LTE network 400 having combined with an existing 2G/3G radio access network.

FIG. 5 illustrates an alternate connection of a passive probe 502 to a network 500.

FIG. 6 is an embodiment of a method 600 of performing lawful intercept.

FIG. 7 illustrates one example of a suitable operating environment 700 in which one or more of the present examples may be implemented.

FIG. 8 is an embodiment of a network 800 in which can provide secure communication between a probe 802 and a monitoring platform.

### DETAILED DESCRIPTION

Many jurisdictions around the world require network operators, such as cellular and land line phone operators, to assist law enforcement agencies in lawfully intercepting communications that are transmitted over the network. For example, the United States passed the Communications Assistance for Law Enforcement Act of 1994 (CALEA) which enhances the ability of law enforcement and/or intelligence agencies to monitor communications sent over networks. CALEA requires telecommunications carries and manufacturers to modify their networks and/or hardware to allow federal agencies to monitor communications that are transmitted over the telecommunications networks using telecommunications equipment. Other jurisdictions around the world have similar requirements.

As technology continues to develop, telecommunications providers and equipment manufacturers have to continually update their networks and devices to comply with CALEA type requirements. Generally, there are two different types of lawful intercept can be employed. The first type is an active approach. The active approach requires modification to the software and equipment that are part of a network in order to intercept data. Due to the modifications, an active approach is generally more costly and provides more security weaknesses. A second type of lawful intercept is a passive approach. A passive approach does not require any modification to the components of a network. Rather, a device, such as a probe, may tap into a network and identify communications for interception without requiring modification, or even an understanding of how the network equipment works. For those reasons, the passive approach can be less costly and more secure than an active approach.

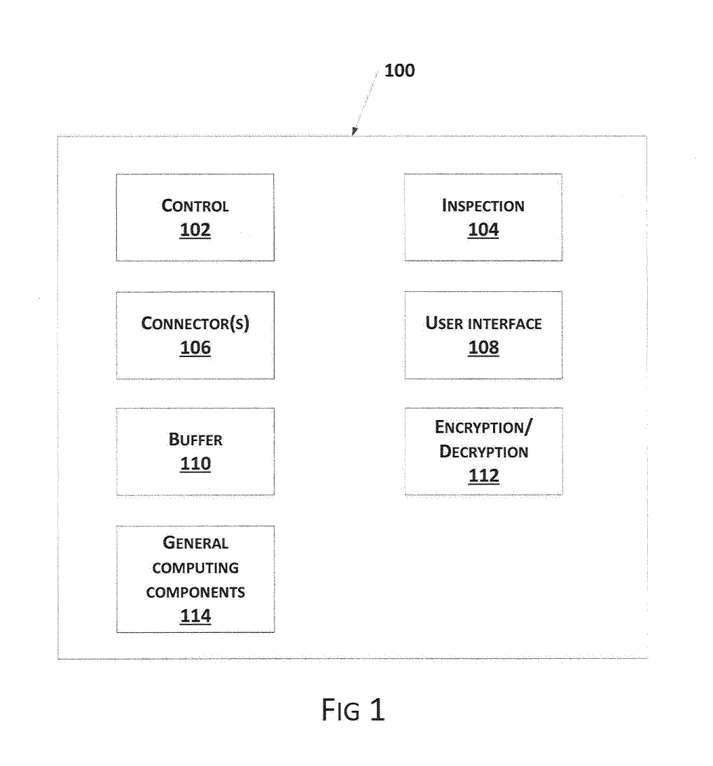

FIG. 1 is an embodiment of a probe 100 capable of performing lawful intercept of communication transmitted over a network. In embodiments, a communication can be a voice communication (e.g., a phone call or information about a phone call) a data communication (e.g., a text message, email, video, picture, etc.) or a combination of both (e.g., a video conference, a voice conference with shared data, etc.). Communications may comprise one or more data packets. A communication may be a discrete communication, e.g., a picture, a video file, an audio file, etc., comprising a single file, or a streaming communication, e.g., a streaming video or audio transmissions. A network may be any type of network capable of transmitting voice communications, data communications, or a combination of the two. Exemplary networks include, but are not limited to, the Internet, a plain old telephone service (POTS) network, a Voice Over IP (VoIP) network, a cellular network (e.g., a 2G network, 3G network, Long Term Evolution (LTE) network, a LTE 4G network, etc.), a local area network (LAN), a wide area network (WAN), or any other type of network capable of transmitting data.

Probe 100 may be an active probe or a passive probe. In embodiments, one approach is the use of a device called an LI gateway or mediation system. This device relies on optional modules that are typically made available from major equipment manufacturers of network hardware (e.g., Cisco, Juniper, Acme Packet, Alcatel Lucent, and many others). These modules may be proprietary interfaces into the hardware components. When a court order for an intercept is implemented, it is provisioned into the mediation system. The mediation system has an understanding of the different hardware components that it is connected to, and the mediation system is operable communicates with those hardware components to create the necessary filters and other mechanisms for the legal intercept. When the hardware components detect an event provisioned by the mediation system, the hardware components are operable to send information back to the mediation system. The mediation system merges intercepted events and data into standard messages (e.g., using the ATIS 678 and IAS CALEA standards) and sends it on (e.g., to the law-enforcement agency or trusted third party for the law enforcement agency).

In alternate embodiments, a passive probe is capable of performing a lawful intercept independent of the equipment in the network. In embodiments, a passive probe relies on the existence of standard protocols passing along certain network segments. The passive probe typically uses deep packet inspection to analyze these protocols (e.g., SIP and RTP protocols in the case of VoIP; however, other protocols may be used depending on the communication protocols employed by the network). A passive probe may attach to multiple network segments. In further embodiments, a passive probe may be provisioned similar to a mediation system and that is capable of formatting events and data according to legal intercept standards in the similar manner as a mediation system.

In embodiments, probe 100 may comprise various different components, such as components 102-118 depicted in FIG. 1. Each component may comprise hardware (e.g., an integrated circuit, an application-specific integrated circuit (ASIC), etc.), software (e.g., a software module), or a combination of hardware or software to perform the functionality described herein. While FIG. 1 and its accompanying description detail a discrete set of components, one of skill in the art will appreciate that the number of discrete components that make up probe 100 may differ without departing from the scope of this disclosure. For example, the functionality of each described component may be performed by two or more separate components. Similarly, the functionality of two or more discrete components described with respect to FIG. 1 may be performed by a single component (e.g., the control component 102 and the inspection component 104 may be combined into a single component, the control component 102 and the user interface component 108 may be combined, etc.).

In embodiments, the probe 100 may include a control component 102. The control component 102 may provision the probe 100 to perform lawful intercept of communications according to a defined standard. For example, the control component 102 may provision the probe to enable or disable different input connectors that are part of the probe 100. In embodiments, the control component may provision the probe 100 to intercept IP data communications, such as, but not limited to IPv4 and IPv6 communications over Ethernet, including PPP, DHCP, and RADIUS IP address discovery, and including SIP VoIP. In other embodiments, the control component 102 may provision the probe 100 to intercept GTP-C (control) and GTP-U (user packets) over an LTE S5/S8 interface. In still another embodiment, the control component 102 may provision the probe 100 to intercept GTP-C (control) and GTP-U (user packets) over an LTE S11 interface. One of skill in the art will appreciate that the control component 102 may be provision the probe 100 in any number of ways depending on the type of network and data that the probe is connected to.

In embodiments, the control component 100 may also detail the different criterion that the probe 100 will use to determine whether or not to intercept a communication or record data about a communication. Table 1 provides an exemplary intercept criterion that may be provisioned by the control component.

TABLE 1
Exemplary Interception Criteria

| Intercept | |
|---|---|
| Criterion | Definition of Criterion |
| IMSI | International Mobile Subscriber Number. 15 or fewer decimal |
| | digits. |
| MSISDN | Mobile Subscriber Integrated Services Digital Network Number. |
| | 15 or fewer decimal digits. |
| MEI | Mobile Equipment Identifier. 14 decimal digits, or 15 (where the |
| | 15^{th} is the check digit or zero. |

One of skill in the art will appreciate that that the intercept criteria provisioned by the control component 102 may change depending on the type of data being intercepted. For example, Table 2 provides exemplary intercept criteria that the control component 102 may provision for intercepting VoIP call.

TABLE 2
Exemplary Interception Criteria for VoIP Intercept

| Intercept Criterion | VoIP Match |
|---|---|
| user@hostname | sip: user@hostname |
| user@ip_address | sip: user@ip_address |
| phone_number@hostname | sip: phone_number@hostname |
| phone_number@ip_address | sip: phone_number@ip_address |
| phone_number | sip: phone_number |
| | tel: phone_number |
| hostname | sip: hostname |
| ip_address | sip: ip_address |
| IMSI | May be used to identify an |
| | intercept subject's SIP traffic |
| | independent of what identifiers |
| | the intercept subject uses in the |
| | SIP traffic. |
| MSISDN | May be used to identify an |
| | intercept subject's SIP traffic |
| | independent of what identifiers |
| | the intercept subject uses in the |
| | SIP traffic. |
| MEI | May be used to identify an |
| | intercept subject's SIP traffic |
| | independent of what identifiers |
| | the intercept subject uses in the |
| | SIP traffic. |

While specific intercept criteria are provided in Tables 1 and 2, one of skill in the art will appreciate that different types of criterion may be defined and/or provisioned by the control component without departing from the spirit of this disclosure.

Probe 100 may also include an inspection component 104. In embodiments, the inspection component may analyze communications transmitted over the network received by the probe 100 to determine whether or not a particular communication, or a portion of a particular communication, is to be lawfully intercepted. In embodiments, the determination may be made based upon one or more provisions provided or otherwise defined by the control component 102. For example, the intercept component 104 may analyze data received over a specific connector (e.g., GTP-C (control) and GTP-U (user packets) over an LTE S5/S8 interface) or may identify communication, or data making up a communication, based on provisioning criteria (e.g., identify communications from user@hostname, communications from a specific telephone number, etc.). In embodiments, intercept component 104 examines data that makes up the communication to determine whether or not the communication should be lawfully intercepted based up the defined provisions. For example, intercept component 104 may perform deep packet inspection on the data of the communication. However, one of skill in the art will appreciate that any type of comparison or analysis of the data may be employed by the intercept component 104 to determine whether the communication should be lawfully intercepted.

Intercept component may also determine the type of intercept to perform based upon data from the control component 102. One type of intercept is a pen-register intercept. In a pen-register intercept, information about a communication may be intercepted by the probe 100. Alternatively, a content intercept may also be performed. A content intercept may include the content of the communication in addition to information about the communication. In using the probe with IAS for LTE intercepts, the key LTE events tracked are a subject attaching/detaching to the network, IP address assignment, connecting/disconnecting to the public data network, and location information. Such information easily maps into the existing IAS messages. Where there are useful information elements in relevant LTE messages that do not map to specific portions of an IAS message, such useful information can be mapped into the AccessSessionCharacteristics parameter of the IAS Access messages (e.g., the LTE Radio Access Type data). Additionally useful LTE events can be mapped into the IAS AccessSignalingMessageReport. While the intercept component 104 can format intercepted communications, or data about an intercepted communication, into an IAS message, other types of formatting can be used without departing from the spirit of the present disclosure. Such formats include, but are not limited to 3GPP formats (e.g., SGP TS 33.108), or other types of formats known to the art. One of skill in the art will appreciate that the type of format used may also be determined by a trusted third party or a law enforcement agency that receives intercepted communications from the probe 100.

In embodiments, in addition to identifying communications for lawful intercept, the intercept component 104 may format the data for transmission to a trusted third party or a law enforcement agency. In one embodiment, intercepted communications may be formatted according to an IAS standard (e.g., ATIS-1000013.2007, ATIS-1000013a.2009, ATIS-1000031, ATIS-1000052, etc.). In embodiments, formatting the data according to IAS may provide more useful information to a trusted third party or a law enforcement agency. For example, when performing a pen-register intercept, IAS formatted data provides addressing information (e.g., to which other IP addresses and ports is the subject communicating) in its packet header reports and packet summary reports.

Probe 100 may also include one or more connectors 106. In embodiments, a connector may be a port, an interface, a pin set, a wireless transmitter/receiver (e.g., WiFi, Bluetooth, or infrared components), or any other type of connection capable of receiving and/or transmitting data. In one embodiment, connectors 106 may be operable to tap into an S5/S8 interface between a Serving Gateway (S-GW) and Packet Data Network Gateway (P-GW) of an LTE network. In such embodiments, connectors 106 may receive communications transmitted over the network at the S5/S8 connection of the probe 100 for analysis by the inspection module 104. In another embodiment, connectors 106 may be operable to tap into an S11 interface between a Mobility Management Entity (MME) and a combined Serving Gateway and Packet Data Network Gateway (S-GW/P-GW) device. In such embodiments, connectors 106 may receive communications transmitted over the network at the S11 connection of the probe 100 for analysis by the inspection module 104. In yet another embodiment, connectors 106 may be operable to tap into an S4 interface between a Serving GPRS Support Node (SGSN) and a combined Serving Gateway and Packet Data Network Gateway (S-GW/P-GW) device. In such embodiments, connectors 106 may receive communications transmitted over the network at the S4 connection of the probe 100 for analysis by the inspection module 104. One of skill in the art will appreciate that the type of connections and or interfaces provided by connectors 106 may differ depending on the type of network that the probe 100 is monitoring.

In embodiments, in addition to the input connections described above, connectors 106 may also include output connections. For example, connectors 106 may include one or more output port, an interface, a pin set, a wireless transmitter, etc. operable to transmit intercepted communications to a monitoring platform that may be part of the network, part of a trusted third party network, or part of a law enforcement agencies network. In such embodiments, connections may be a secure connection, such as a dedicated wire connection, a virtual private network (VPN) connection, or any other type of secure connection known to the art. In such embodiments, the secure connections to the monitoring platform may be two way connections. In such embodiments, the secure connections may receive provisioning information (e.g., the type of information described with respect to the control component 102) from a monitoring platform.

Probe 100 may also include a user interface component 108. In embodiments, the user interface component 108 may be operable to generate a user interface that allows users to adjust the settings of the probe 100. For example, the user interface component may be operable to receive user input over a secure connection (e.g., a connection to the monitoring platform) to define or otherwise adjust setting or provisions for the probe 100. In embodiments, the user interface may be operable to generate a display and receive input to adjust any of the provisioning settings or interception criteria discussed with respect to the control component 102. In embodiments, the user interface component 108 is operable to generate a control page user interface for enabling and disabling monitoring by the probe. For example, the control user interface can be used to provision one or more connectors 106 for receiving communications for interception. The control user interface may also be used to adjust provisioning settings such as the exemplary settings described with respect to the control component 102.

The user interface component 108 may also be operable to display an intercept user interface. The intercept user interface may identify criteria used to determine whether a communication should be intercepted. Exemplary criteria include, but are not limited to, a phone number, an IP address, an IMSI, and MSISDN, an email address, etc. The intercept user interface may be used to set general intercept criteria (e.g., criteria that applies to all communications) or specific intercept criteria (e.g., criteria that applies to a specific user, account, etc.). The user interface component may also be operable to display a Voice Over IP (VoIP) user interface to provide for the selection of criteria used to identify a VoIP communication for lawful interception. Example criteria included, but are not limited to, the criteria provided in Table 2. One of skill in the art will appreciate that the user interface component 108 may be used to provide administrative access to adjust the operation of the probe 100. In other embodiments, the user interface may also display data related to the operation of the probe 100. Such data includes, but is not limited to, status information, interception statistics, data about intercepted communications, and/or the content of intercepted communications.

Probe 100 may also include a buffer 110. The buffer 100 may be used to store intercepted communications to prevent the loss of intercept information due to communications failure with the monitoring platform. Buffering may be provisioned by the control component 102. For example, the buffer 100 may be set to never buffer data, buffer only in the event of failures, or buffer everything. In further embodiments, the amount of time that data remains in the buffer may also be provisioned by the control component 102.

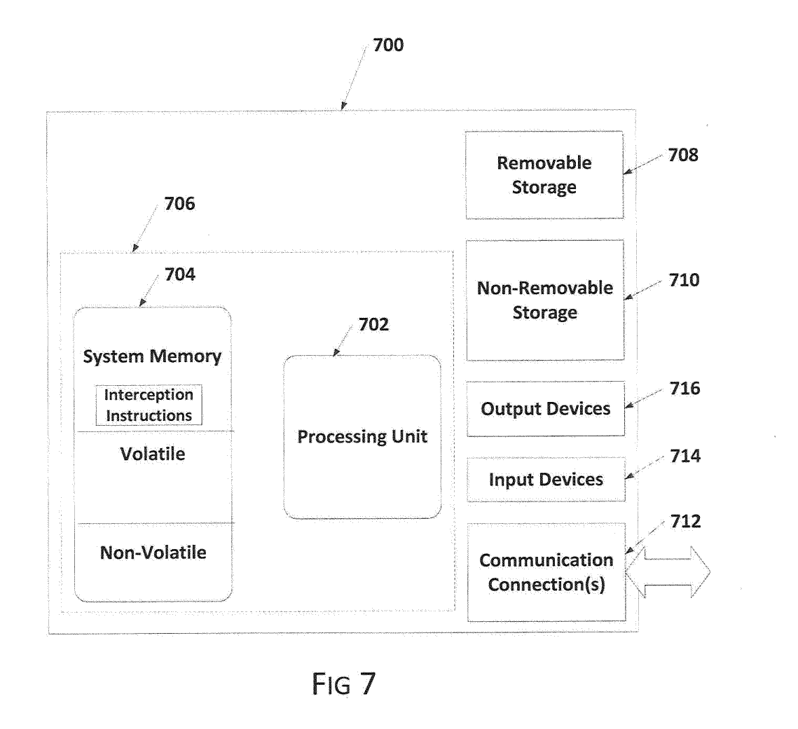

Probe 100 may also include an encryption/decryption component 112. In embodiments, content transmitted over the network may be encrypted. In such environments, the probe 100 may have to decrypt the data prior to analyzing the data to determine if the data should be lawfully intercepted. In further embodiments, the probe 100 may encrypt lawfully intercepted data prior to transmitting the intercepted data to a monitoring platform. In encrypting the intercepted data provides additional security and protections for privacy of individuals whose communications have been intercepted. Any type of encryption/decryption algorithm may be employed by encryption/decryption component 112. Probe 100 may also include general computing components 114. For the sake of brevity, these components are described in more detail with respect to FIG. 7.

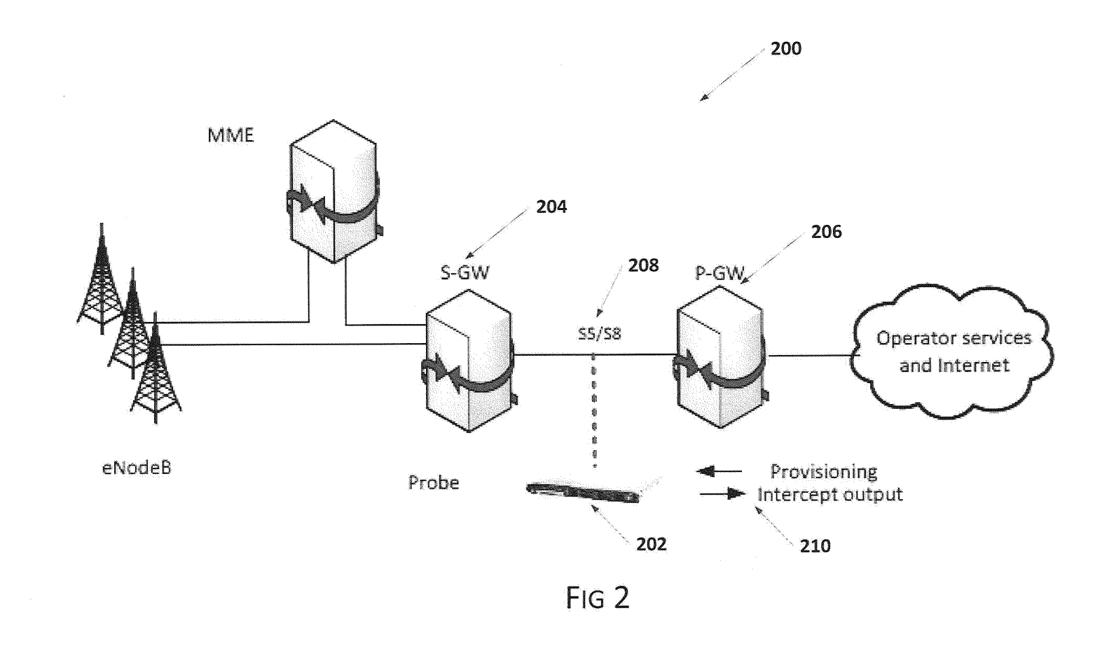

Having described embodiments of a probe, the disclosure will now turn to the various connections and or interfaces that the probe is operable to connect to various different network topologies. One of skill in the art will appreciate that although specific network topologies and connections are provided herein, the probe may implement other connections without departing from the spirit of this disclosure. FIGS. 2-5 illustrate various different connections that may be implemented by a passive probe in a network.

FIG. 2 is an embodiment of a passive probe 202 interfacing with an LTE network 200. In the illustrated embodiment, the LTE network 200 includes a separate Serving Gateway (S-GW) 204 and Packet Data Network Gateway (P-GW or PDN Gateway) 206. In embodiments, the passive probe 202 is capable of intercepting communications without modification to any of the LTE network's 200 hardware or software. As such, the functions of the S-GW 204 and P-GW 206 are irrelevant to the passive probe 202. In order to receive and analyze communications for interception, the passive probe 202 connects to the LTE network 200 by a tap 208 into the S5/S8 interface between the S-GW 204 and P-GW 206. In embodiments, the passive probe 202 also has a connection 210 to a monitoring platform to receive provisioning information and deliver intercepted communications. The connection 210 may be a secure connection, such as, but not limited to a VPN connection. Other elements of the LTE network 200 displayed in FIG. 2 are known to the art and are not described in detail herein.

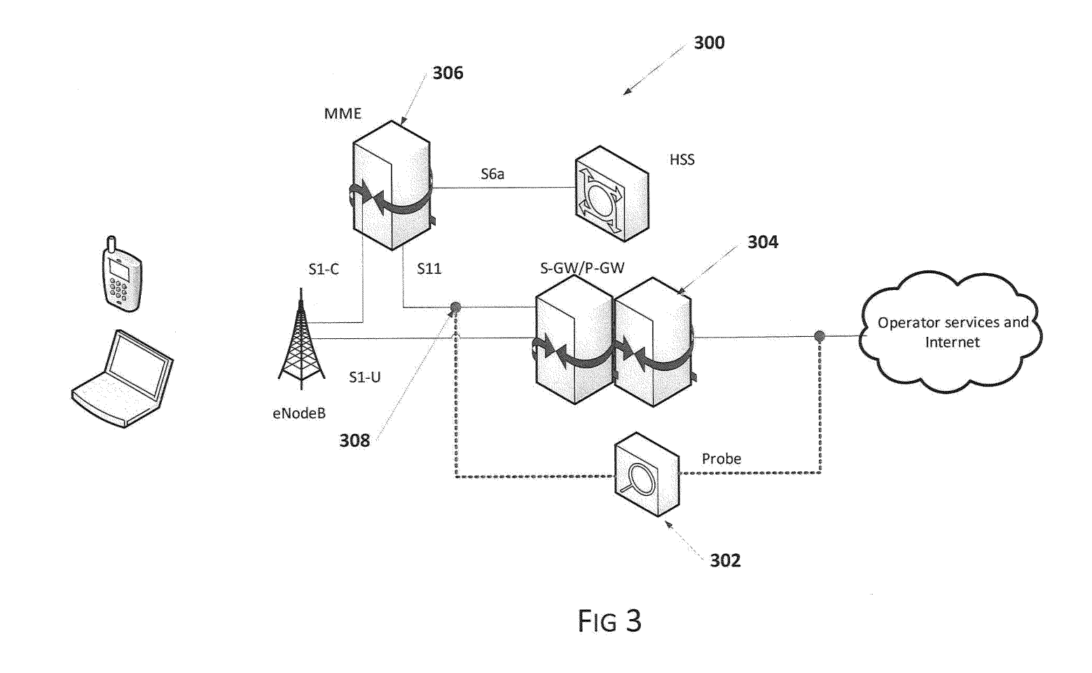

FIG. 3 is an embodiment of a passive probe 302 interfacing with an LTE network 300 having an alternate topology. Rather than having separate S-GW and P-GW devices, LTE network 300 includes a single combined Serving Gateway and Packet Data Network Gateway (S-GW/P-GW) device 304. In such embodiments, the passive probe 302 is operable to connect to the LTE network 300 by a tap 308 on the S11 interface between the S-GW/P-GW device 304 and the Mobility Management Entity (MME) 306. In embodiments, the passive probe 302 is capable of intercepting communications without modification to any of the LTE network's 300 hardware or software. As such, the functions of the S-GW/P-GW device 304 and the MME 306 are irrelevant to the passive probe 302. In embodiments, the passive probe 302 also has a connection (not shown) to a monitoring platform to receive provisioning information and deliver intercepted communications. The connection may be a secure connection, such as, but not limited to a VPN connection. Other elements of the LTE network 300 displayed in FIG. 3 are known to the art and are not described in detail herein.

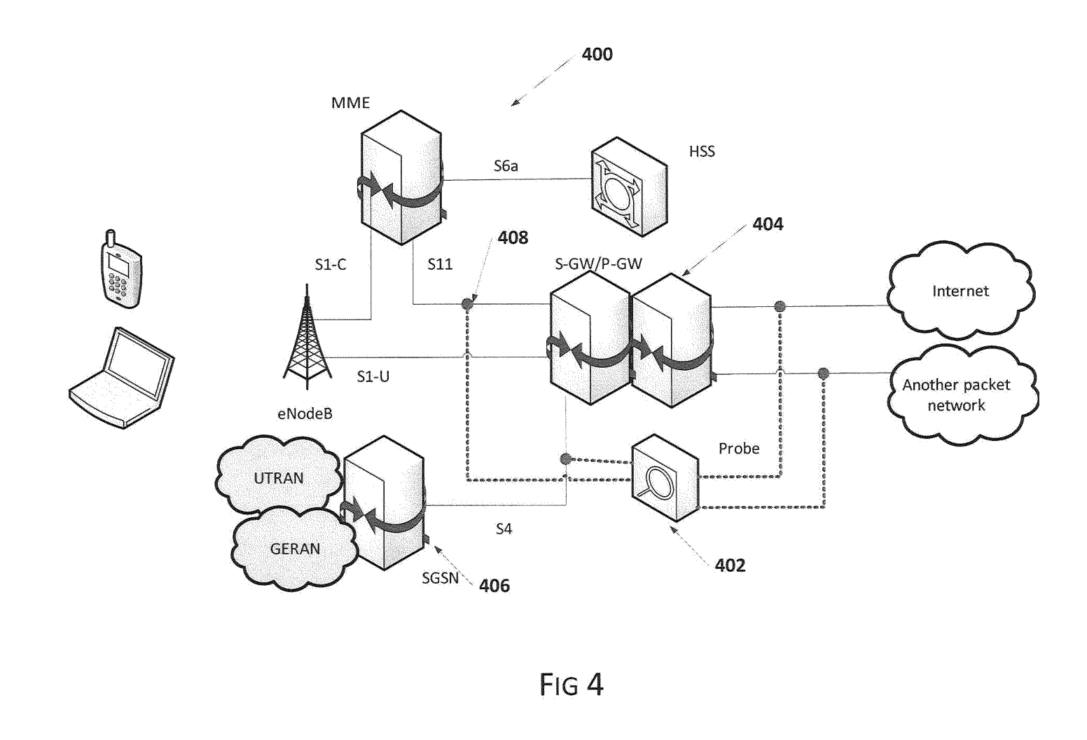

FIG. 4 is an embodiment of a passive probe 402 interfacing with an LTE network 400 having combined with an existing 2G/3G radio access network. In the embodiment illustrated in FIG. 4 the passive probe 402 is capable of intercepting communications transmitted via the LTE packet core as well as communications transmitted over the 2G/3G radio access network. In the illustrated embodiment, passive probe 402 is operable to connect to the LTE network 400 by a tap 408 between the combined Serving Gateway and Packet Data Network Gateway (S-GW/P-GW) device 404 and the Serving GPRS Support Node (SGSN) 406. In embodiments, the passive probe 402 is capable of intercepting communications without modification to any of the combined LTE and 2G/3G network's 400 hardware or software. As such, the functions of the S-GW/P-GW device 404 and the SGSN 406 are irrelevant to the passive probe 402. In embodiments, the passive probe 402 also has a connection (not shown) to a monitoring platform to receive provisioning information and deliver intercepted communications. The connection may be a secure connection, such as, but not limited to a VPN connection. Other elements of the combined LTE and 2G/3G network 400 displayed in FIG. 4 are known to the art and are not described in detail herein. In an alternate embodiment not illustrated, if the combined LTE and 2G/3G network includes separate S-GW and P-GW devices, the passive probe can a tap into the S5/S8 as illustrated in FIG. 2 to intercept communications sent over the combined LTE and 2G/3G network.

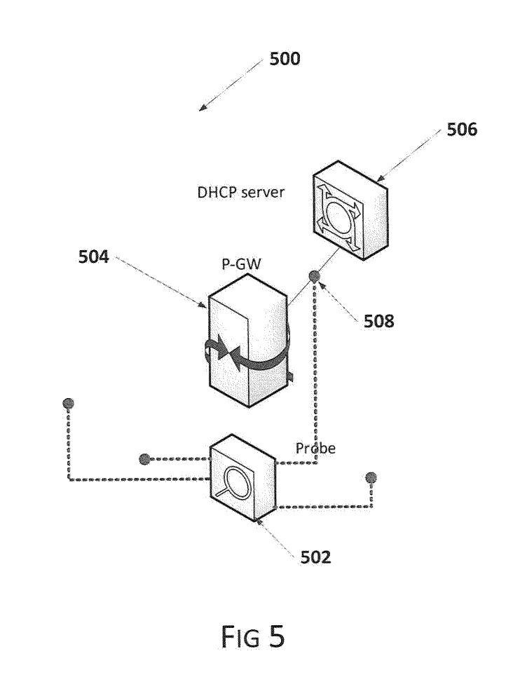

FIG. 5 illustrates an alternate connection of a passive probe 502 to a network 500. Typically the P-GW 504 does IP address assignment, and this is handled by the passive probe as illustrated in FIGS. 2-4. However, it is also possible, as an operator choice, for the LTE network 500 to forego IP address assignment and to use the DHCP protocol to interact with a DHCP server 506. If this is done, the probe needs a connection to the network segment on which the DHCP protocol will appear. As such, the passive probe 502 is operable to connect to a tap 508 on the interface between the P-GW 504 and the DHCP server 506. In embodiments, the passive probe 502 is capable of intercepting communications without modification to any of the LTE network's 500 hardware or software. As such, the functions of the P-GW 504 and the DHCP server 506 are irrelevant to the passive probe 502. In embodiments, the passive probe 502 also has a connection (not shown) to a monitoring platform to receive provisioning information and deliver intercepted communications. The connection may be a secure connection, such as, but not limited to a VPN connection.

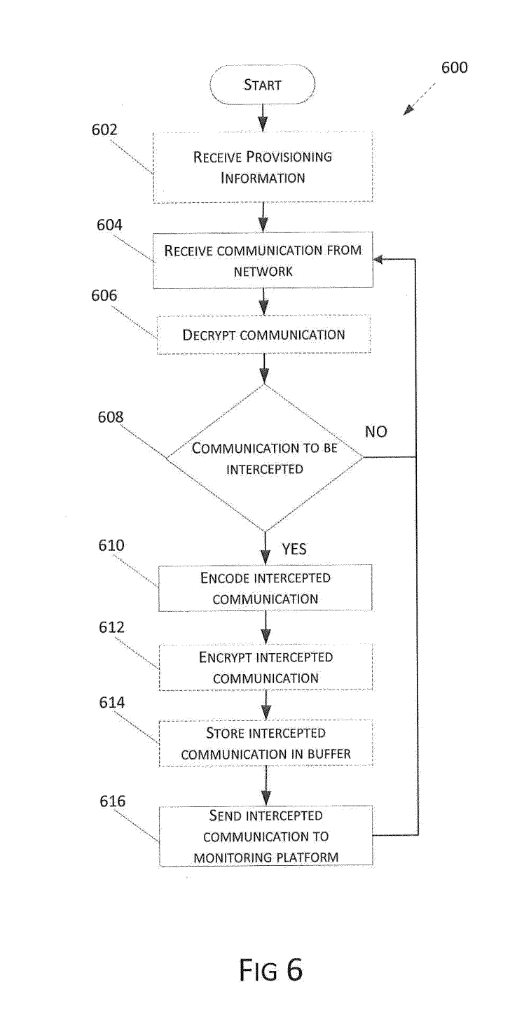

FIG. 6 is an embodiment of a method 600 of performing lawful intercept. In embodiments, the method 600 may be performed by a probe, such as a passive probe. Flow begins at optional operation 602 where provisioning information is received. In embodiments, the provisioning information may be received by a monitoring platform in communication with the device performing the method 600. Provisioning information may include, but is not limited to, the provisioning data discussed with respect to the control component 102 of FIG. 1. In embodiments, the provision information optionally received at operation 602 may be received via interaction with a user interface component that is part of the device performing the method 600.

Flow continues to operation 604 where data representing a communication is received. The data may be an individual file or message or, in alternate embodiments, the data may be streamed data comprising multiple packets of information, such as data from a streamed video or a voice call. In embodiments, the data received at operation 604 is data transmitted over a network, such as an LTE network. The data may be received via one or more taps into the network, such as, but not limited to, the taps described with respect to FIGS. 2-5.

Flow continues to optional operation 606 where the received communication is decrypted. In embodiments, the data received at operation 604 may be encrypted. Prior to analyzing the data to determine whether the communication should be intercepted, the data may be decrypted at operation 606. In addition or alternative to decrypting the communication, the data received at operation 604 may be reformatted or otherwise manipulated in preparation for analysis at operation 606.

Flow continues to determination operation 608 where the received data is analyzed to determine whether the communication should be lawfully intercepted. In embodiments, the analysis performed at operation 608 may operate according to one or more provisions received at operation 602 or previously stored on the device performing the method 600. In one embodiment, the analysis may comprise a deep packet inspection on the data received at operation 604. However, other types of data analysis and/or inspection may be performed at operation 608 without departing from the spirit of the disclosure. If upon analysis a determination is made that the received communication is not to be intercepted, flow branches NO and returns to operation 604 where the next communication is received for analysis.

Upon determining that the data should be lawfully intercepted, flow branches YES to operation 610. At operation 610, the communication, or information about the communication, is encoded or formatted into an intercept standard, such as the ATIS IAS or 678 standard. Flow continues to optional operation 612. At operation 612 the intercepted communication may be encrypted to provide additional security for the communication prior to sending the communication to a trusted third party or law enforcement agency. The type of encryption may be dictated by the trusted third party or the law enforcement agency.

Flow continues to optional operation 614 where the data is stored in a buffer. The data may be buffered to ensure that the communication is maintained in case of the occurrence of a communication failure when sending the intercepted communication to the trusted third party or the law enforcement agency. Whether or not the intercepted communication is buffered and the length of time that the intercepted communication is to be buffered may be defined by the provisioning information received at operation 602 or previously set on the device performing the method 600.

Flow continues to operation 616 where the intercepted communication is sent to a monitoring platform. The monitoring platform may be part of the network in which the communication was transmitted, part of a trusted third party's network, part of a law enforcement agency's network, or a combination of any of the above. Additional, the intercepted communication may be transmitted to multiple monitoring platforms at operation 616. In embodiments, the intercepted communication is transmitted over a secure connection, such as, but not limited to a VPN connection. In embodiments flow may then returns to operation 604 where the next communication is received for analysis.

FIG. 7 illustrates one example of a suitable operating environment 700 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, smartphones, tablets, distributed computing environments that include any of the above systems or devices, and the like. In embodiments, the probe and/or the network hardware described herein may be implemented using an operating environment such as environment 700.

In its most basic configuration, operating environment 700 typically includes at least one processing unit 702 and memory 704. Depending on the exact configuration and type of computing device, memory 704 (storing, among other things, instructions to perform the lawful interception method described herein) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as touch screens, keyboard, mouse, pen, voice input, etc. and/or output device(s) 716 such as a display, speakers, printer, etc. Also included in the environment may be one or more communication connections, 712, such as LAN, WAN, point to point, Bluetooth, RF, etc.

Operating environment 700 typically includes at least some form of computer readable media. Computer readable media can be any available media that can be accessed by processing unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

In some embodiments, the components described herein comprise such modules or instructions executable by computer system 700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 700 is part of a network that stores data in remote storage media for use by the computer system 700.

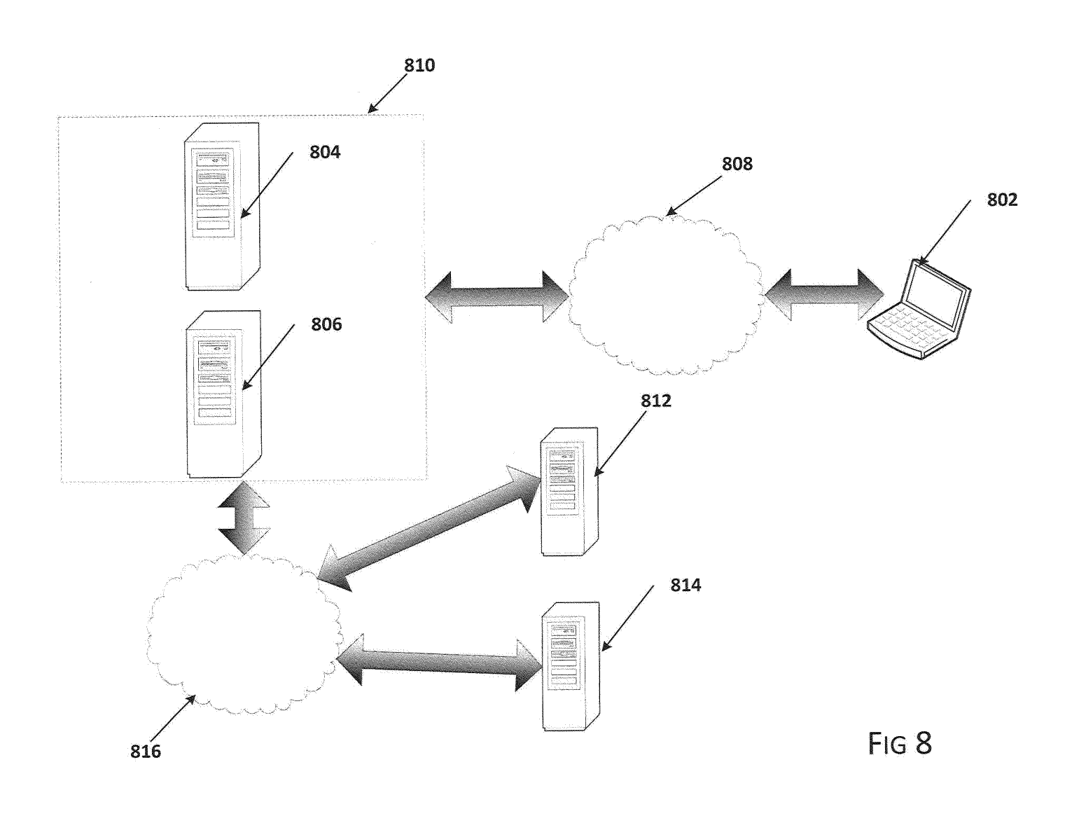

FIG. 8 is an embodiment of a network 800 in which can provide secure communication between a probe 802 and one or more monitoring platforms. In embodiments, probe 802, may communicate with a monitoring platform 810 which may include one or more servers or devices, such as servers 804 and 806, via a secure network 808. In embodiments, the secure network can be a VPN; however, other types of secure networks can be practiced without departing from the spirit of this disclosure. In embodiments, servers 804 and 806 may be any type of computing device, such as the computing device illustrated in FIG. 7. Network 808 may be any type of network capable of facilitating secure communications between the client device and one or more servers 804 and 806. Examples of such networks include, but are not limited to, LANs, WANs, cellular networks, and the like.

In embodiments, monitoring platform 810 is capable of receiving intercepted communications from the probe 802 and/or interacting with the probe 802 via a user interface or using other types of messaging to transmit provisioning data to the probe 802. The monitoring platform may be part of a trusted third party network, a law enforcement or intelligence agency, a telecommunications network, or any other type of network. In embodiments where the monitoring platform is not part of a law enforcement agency, the monitoring platform may be connected to one or more law enforcement agency devices 812 and 814 via network 816. In such embodiments, the monitoring platform may transmit intercepted communications received by the probe 802 to law enforcement agency devices 812 and 814. In such embodiments, the monitoring platform may be part of a trusted third party that collects intercepted communications on behalf of law enforcement agencies.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure described some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A passive probe for lawfully intercepting communications in a network, the passive probe comprising:
a first connector to the network, wherein the first connector directs communications transmitted over the network to the passive probe;
an inspection component identifying at least one packet for lawful interception, wherein the inspection component operates independently from a plurality of components that are part of the network; and
a second connector to a monitoring platform, the second connector being a secure connector to the monitoring platform, wherein the second connector is operable to transmit the at least one packet identified for lawful interception to the monitoring platform.

2. The passive probe of claim 1, wherein the network is a Long Term Evolution (LTE) network.

3. The passive probe of claim 2, wherein the first connector is operable to tap into an S5/S8 interface between a Serving Gateway (S-GW) and Packet Data Network Gateway (P-GW) of the LTE network.

4. The passive probe of claim 2, wherein the first connector is operable to tap into an S11 interface between a Mobility Management Entity (MME) and a combined Serving Gateway and Packet Data Network Gateway (S-GW/P-GW) device.

5. The passive probe of claim 1, wherein the network is a 2G/3G radio access network that uses an LTE Evolved Packet Core.

6. The passive probe of claim 5, wherein the first connector is operable to tap into the S4 interface between a Serving GPRS Support Node (SGSN) and a combined Serving Gateway and Packet Data Network Gateway (S-GW/P-GW) device.

7. The passive probe of claim 1, wherein the inspection component is capable of performing at least one of pen register intercepts and content intercepts.

8. The passive probe of claim 1, wherein the communication is a voice communication, and wherein the passive probe identifies the at least one packet based at least in part on one of:
A SIP URI;
an International Mobile Subscriber Identity (IMSI);
a Mobile Station International Subscriber Directory Number (MSISDN);
a telephone number; and
a Mobile Equipment Identity (MEI).

9. The passive probe of claim 1, wherein the communication is a data communication, and wherein the passive probe identifies the at least one packet based at least in part on one of:
International Mobile Subscriber Identity (IMSI);
a Mobile Station International Subscriber Directory Number (MSISDN);
a telephone number;
a Mobile Equipment Identity (MEI); and
an IP address.

10. A passive probe for lawfully intercepting communications in a Long Term Evolution (LTE) network, the passive probe comprising:
a first connector to the network, the first connector directs a plurality of data packets associated with a communication transmitted over the LTE network to the passive probe, wherein the first connector is operable to tap into at least one of:
an S5/S8 interface between a Serving Gateway (S-GW) and a Packet Data Network Gateway (P-GW) of the LTE network; and
an S11 interface between a Mobility Management Entity (MME) and a combined Serving Gateway and Packet Data Network Gateway (S-GW/P-GW) device;
an inspection component for performing deep packet inspection on a plurality of data packets transmitted over the network and identifying at least one packet for lawful interception, wherein the inspection component operates independently from the LTE network; and
a second connector to a monitoring platform, the second connector being a secure connector to the monitoring platform, wherein the second connector is operable to transmit the at least one packet identified for lawful interception to the monitoring platform.

11. The passive probe of claim 10, wherein the monitoring platform is associated with at least one of:
a trusted third party; and
a law enforcement agency.

12. The passive probe of claim 10, wherein the passive probe comprises a user interface component.

13. The passive probe of claim 12, wherein the user interface component is capable of generating a control page user interface, and wherein the control page user interface provides for the enabling of monitoring for at least one input of the passive probe.

14. The passive probe of claim 12, wherein the user interface component is capable of generating an intercept user interface, and wherein the intercept user interface provides for the selection of at least one criterion used to identify the at least one packet for lawful interception.

15. The passive probe of claim 12, wherein the user interface component is capable of generating a Voice Over IP (VoIP) user interface, wherein the VoIP user interface provides for the selection of at least one criterion used to identify a VoIP communication for lawful interception.

16. The passive probe of claim 10, wherein the passive probe further comprises a buffer for storing the at least one packet identified for lawful intercept.

17. The passive probe of claim 10, wherein the secure connector is a virtual private network (VPN) connector.

18. A system comprising:
a Serving Gateway (S-GW);
a Packet Data Network Gateway (P-GW); and
a passive probe for lawfully intercepting communications in a Long Term Evolution (LTE) network, the passive probe comprising:
a first connector to the network, the first connector directs a plurality of data packets associated with a communication transmitted over the LTE network to the passive probe, wherein the first connector is operable to tap into:
an S5/S8 interface between the Serving Gateway (S-GW) and the Packet Data Network Gateway (P-GW) of the LTE network; and
an S11 interface between a Mobility Management Entity (MME) and a combined Serving Gateway and Packet Data Network Gateway (S-GW/P-GW) device; and
an inspection component for performing deep packet inspection on a plurality of data packets distributed over the network and identifying at least one packet for lawful interception, wherein the inspection component operates independently from the plurality of components that are part of the LTE network; and
a second connector to a monitoring platform, the second connector being a secure connector to the monitoring platform, wherein the second connector is operable to transmit the at least one packet identified for lawful interception to the monitoring platform.

19. The system of claim 18, further comprising a monitoring platform for receiving the at least one packet for lawful interception, and wherein the passive prove further comprises:
a second connector to the monitoring platform, the second connector being a secure connector to the monitoring platform, wherein the second connector is operable to transmit the at least one packet identified for lawful interception to the monitoring platform.

20. The system of claim 18, wherein the passive probe further comprises a user interface component, and wherein the user interface component is operable to generate at least one of:
a control page user interface, and wherein the control page user interface provides for the enabling of monitoring for at least one input of the passive probe;
an intercept user interface, and wherein the intercept user interface provides for the selection of at least one criterion used to identify the at least one packet for lawful interception; and
a Voice Over IP (VoIP) user interface, wherein the VoIP user interface provides for the selection of at least one criterion used to identify a VoIP communication for lawful interception.
